(19) United States
(12) Patent Application Publication
(10) Pub. No.: US 2007/0048652 A1
(43) Pub. Date: Mar. 1, 2007

(54) Carrier and developer

(76) Inventors: Naoki Imahashi, Mishima-shi (JP); Kimitoshi Yamaguchi, Numazu-shi (JP); Masashi Nagayama, Mishima-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/508,922

(22) Filed: Aug. 24, 2006

(30) Foreign Application Priority Data
Aug. 25, 2005 (JP) 2005-244346
Mar. 14, 2006 (JP) 2006-069765
Jul. 28, 2006 (JP) 2006-205766

(51) Int. Cl. G03G 9/113

(52) U.S. Cl. 430/111.33; 430/111.35

(57) ABSTRACT

The present invention provides a carrier which contains core material particles having magnetism and a coating layer on the surfaces of the core material particles; in which the particle density of the core material particles is 4.0 g/cm³ to 6.0 g/cm³, and the bulk density of the core material particles is 2.0 g/cm³ to 3.0 g/cm³; and also provides a developer using the carrier, an image forming method using the developer, an image forming apparatus using the developer, and a process cartridge using the developer.

### BACKGROUND OF THE INVENTION

1. Field of the Invention

The present invention relates to a carrier preferably used in electrophotographic method (xerography), electrostatic recording method, electrostatic printing method, etc., and also relates to a developer using the carrier, an image forming method using the developer, an image forming apparatus using the developer, and a process cartridge using the developer.

2. Description of the Related Art

Developing process of electrophotography is divided into a so-called one-component developing process using primarily a toner, and a so-called two-component developing process using glass beads, and a magnetic carrier, or using a mixture of a coat carrier with the surface thereof coated with a resin, and a toner.

In such a two-component developing process, a carrier is used, and thus a two-component developer has a wider area frictionally charged to toner. In addition, a two-component developing process is more stable in charge property than in a one-component developing process and is advantageous in maintaining high-quality image over a long-period of time and has a high-ability of supplying a toner to developed areas. Thus, a two-component developing process is frequently used particularly in high-speed machine. In an electrophotographic system employing a so-called digital method in which a latent electrostatic image is formed on a photoconductor using a laser beam or the like, and the latent electrostatic image is formed into a visible image, the two-component developing method utilizing the above noted characteristics is also widely employed.

In recent years, to respond to increases in resolution, enhancements in high-light reproductivity of image, improvements in image granularity, and colorization, the minimal unit (one dot) of latent electrostatic image has been minimized, and image density growth has been improved. Especially, developments of image developing systems capable of developing these latent electrostatic images (dots) truthfully have become extremely important, and there have been various proposals from both sides of developing process conditions and a developer (toner and carrier).

From the viewpoint of developing process, making developing gap closely contacted, making a thin layer for photoconductor, and making smaller diameter of a writing beam diameter, etc. are effective, however, these solutions still leave problems in terms of high-cost and reliability.

From the viewpoint of a developer, making smaller particle diameter of toner and making smaller particle diameter of carrier have been studied, and there have been various proposals on use of a carrier having small particle diameters. For example, Japanese Patent Application Laid-Open (JP-A) No. 58-144839 proposes a magnetic carrier containing ferrite particles having a spinel structure and an average particle diameter of 30 μm or less, however, the proposed carrier is not coated with a resin and is used under low-electric field, and is disadvantages in that it is poor developing ability, and the operating life is short.

Japanese Patent No. 3029180 proposes an electrophotographic carrier containing carrier particles having an average particle diameter (D₅₀) of 15 μm to 45 μm at a rate of 50%, the carrier contains carrier particles having a particle diameter less than 22 μm at a rate of 1% to 20%, carrier particles having a particle diameter less than 16 μm at a rate of 3% or less, carrier particles having a particle diameter of 62 μm or more at a rate of 2% to 15%, and carrier particles having a particle diameter of 88 μm or more at a rate of 2% or less, and the specific surface area S₁ of the carrier determined by air permeability method and the specific surface area S₂ of the carrier calculated by the equation S₂=(6/ρ·D₅₀)×10⁴ (ρ represents a specific gravity of carrier) satisfy the formula 1.2≦S₁/S₂≦2.0.

Further, Japanese Patent Application Laid-Open (JP-A) No. 03-233464 proposes a carrier for electrophotographic developer using ferrite as a raw material, which can be obtained by fusing the raw material by high-frequency plasma method or hybrid plasma method. And the carrier has an average particle diameter of 15 μm to 50 μm, a magnetization of 30 emu/g to 95 emu/g at 3,000 Oersted, an appearance density of 1.3 g/cm³ to 3.0 g/cm³, a major axis/minor axis ratio of 1.0 to 1.25, a sphericity of 80% or more, and a specific surface area by air permeability method of 350 cm²/g or more.

When any of these above-noted carriers having smaller particle diameters is used, there are the following advantages:

(1) it is possible to give a sufficient frictional charge to individual toner particles because the carrier has a large surface area per unit volume, and the carrier has less occurrences of toner of low-charge amount and oppositely-charged toner. As the result, background smear hardly occurs, there is fewer amounts of toner dust and image blur in the areas around dots, and the use of the carrier makes it possible to obtain excellent reproductivity.

(2) it is possible to make the average charge amount of toner lowered because the carrier has a large surface area per unit volume and rarely cause background smear, and sufficient image densities can be obtained. Thus, the carrier having small particle diameters enables reducing troubles at the time of using a toner having small particle diameters, and is effective particularly in deriving advantages of use of a toner having small particle diameters.

(3) a carrier having small particle diameters is capable of forming dense magnetic brush. Since the magnetic brush has excellent flowability, magnetic brush trails are hardly left on image surfaces.

However, the each of the proposed carriers having smaller particle diameters has disadvantages in that carrier adhesion easily occurs, and it is difficult to put them into practical use because the carrier adhesion is a cause of occurrences of photoconductor flaws and fixing roller flaws. In particular, when a carrier having a weight average particle diameter less than 30 μm is used, the carrier surface smoothness is drastically improved, and a high quality image can be obtained, however, there are problems that carrier adhesion occurs very easily, and a high-quality image cannot be maintained over a long period of time.

Such a carrier adhesion occurs in a form of carrier or cut off magnetic brush when the conditions of the following formula are met.

Fm<Fc (Fm represents a magnetic binding force, and Fc represents a force of causing carrier adhesion).

The magnetic binding force is represented by the equation, Fm=k×(magnetic moment of carrier)×(magnetic tilt).

The (magnetic moment of carrier) is represented by the equation, (magnetic moment of carrier)=(mass)×(magnetization)=( 4/3)π·r³·ρ×M (“r” represents a radius of carrier, and p represents a particle density of the carrier).

It is found that from the above equation, the magnetic moment of carrier is promotional to r³ and ρ, and thus the magnetic moment of carrier is drastically reduced with reductions in carrier particle diameter. It is further found that the influence of ρ cannot be ignored with reductions in carrier particle diameter.

The force of causing carrier adhesion Fc is associated with a developing potential, a background potential, a centrifugal force applied on carrier, a carrier resistance, and a charge amount of developer. Then, to prevent occurrences of carrier adhesion, it is effective to set various parameters such that the force of causing carrier adhesion Fc can be reduced, however, the current situation is that it is difficult to drastically change the force of causing carrier adhesion Fc because the force closely relates to developing ability, background smear, toner scattering, and the like.

In contrast, for a developer, the use of a toner having smaller particle diameters allows remarkably improving dot reproductivity. However, a developer containing a toner having smaller particle diameters has problems to be solved such as occurrences of background smear, and inadequacy of image density. In a full-color toner having smaller particle diameters, a resin having a low softening point is used to obtain sufficient color toner, however, the amount of pollution (spent) on the carrier surface is more increased than a black toner, and the quality of developer is degraded, and this easily leads to toner scattering and background smear. Further, when combined with high-speed printing rate, it is particularly important that a carrier has stable charge-imparting ability over a long period of time while keeping the carrier durability and preventing occurrences of carrier surface spent.

### SUMMARY OF THE INVENTION

It is therefore an object of the present invention to provide a carrier which causes less occurrence of carrier adhesion, has high-image density and excellent granularity, and enables exhibiting stable charge imparting ability over a long period of time, as well as to provide a developer using the carrier, an image forming method using the developer, an image forming apparatus using the developer, and a process cartridge using the developer.

The carrier of the present invention contains core material particles having magnetism and a coating layer on the surfaces of the core material particles, and the particle density of the core material particles is 4.0 g/cm³ to 6.0 g/cm³, and the bulk density of the core material particles is 2.0 g/cm³ to 3.0 g/cm³.

The developer of the present invention contains the carrier of the present invention and a toner.

The image forming method of the present invention includes at least forming a latent electrostatic image on a photoconductor, developing the latent electrostatic image using the developer of the present invention to form a visible image, transferring the visible image onto a recording medium, and fixing the transferred image on the recording medium.

The image forming apparatus of the present invention has at least a photoconductor, a latent electrostatic image forming unit configured to form a latent electrostatic image on the photoconductor, a developing unit configured to develop the latent electrostatic image using the developer of the present invention, a transferring unit configured to transfer the visible image onto a recording medium, and a fixing unit configured to fix the transferred image on the recording medium.

The process cartridge of the present invention has at least a photoconductor, and a developing unit configured to develop a latent electrostatic image formed on the photoconductor using the developer of the present invention to form a visible image and can be detachably attached to a body of an image forming apparatus.

### BRIEF DESCRIPTON OF THE DRAWINGS

FIG. 1 is a schematic view showing one example of the process cartridge of the present invention.

FIG. 2 is a schematic view showing one example of an image developing apparatus used in the image forming apparatus of the present invention.

FIG. 3 is a schematic view showing one example of an image forming apparatus equipped with the developing unit shown in FIG. 2.

FIG. 4 is a schematic view showing another example of the image forming apparatus of the present invention.

### DESCRIPTION OF THE PREFERRED EMBODIMENTS

(Carrier)

The carrier of the present invention contains core material particles having magnetism and a coating layer on the surfaces of the core material particles, and further has other structures in accordance with the necessity.

<Core Material Particles>

The particle density of the core material particles is typically 4.0 g/cm³ to 6.0 g/cm³, preferably 4.5 g/cm³ to 5.5 g/cm³, and more preferably 4.7 g/cm³ to 5.2 g/cm³. When the particle density is more than 6.0 g/cm³, the coating layer may be easily exfoliated from core material particles because of occurrences of carrier spent from the toner and frictional force of inter-carrier particles, and this may easily lead to degradations in the temporal charge ability. When the particle density is less than 4.0 g/cm³, the magnetic moment of the carrier is easily reduced, and this may lead to frequent carrier adhesion.

The particle density of the core material particles is substantially affected by variations in grain size of the core material particles. With increased variations in grain size, airspaces are easily induced to grain boundary area, and thus the particle density is easily reduced.

The particle density of the core material particles can be controlled by a method in which raw material(s) of core material particles are finely formed up to a particle diameter of 1 μm or less, and the particle diameter of the raw material is uniformed, or by a method in which air embracing events are prevented when core material particles are granulated.

The particle density of the core material particles can be measured by, for example, a dry automatic densitometer (ACUPIC 1330, manufactured by Shimadzu Corporation). The particle density means a density in the case where closed air holes residing inside particles are included into the volume of particles, and concave portions and cracks on particle surfaces and open air holes are not included into the volume of particles.

The bulk density of the core material particles is typically 2.0 g/cm³ to 3.0 g/cm³. When the bulk density is less than 2.0 g/cm³, the magnetic moment per particle is reduced even when the magnetization (emu/g) is large, and thus carrier adhesion easily occurs. As a cause of the reduced bulk density of core material particles, a porous structure of core material particles and convexo-concave structure of core material particle surfaces are conceivable. When the degree of convexo-concaves of core material is particles is large, the distribution of the coating layer thickness may be widen, the charge amount and electric resistivity are easily nonuniform, which may affect occurrences of carrier adhesion with time.

In contrast, as a method of increasing the bulk density of the core material particles, there is a method in which core material particles are subjected to a plasma treatment in the production of core material particles, and a method in which the sintering temperature is raised in the production of core material particles. When the sintering temperature is raised, core material particles are easily fused to each other and are hardly pulverized, and thus it is more preferable that the bulk density of the core material particles be set to 2.5 g/cm³ or less.

Here, the bulk density of the core material particles can be measured as follows in accordance with, for example, the metal powder-appearance density testing method (JIS Z2504).

Core material particles are naturally let out from an orifice having a diameter of 2.5 mm, and the core material particles are poured into a cylindrical stainless vessel of 25 cm³ in volume which is arranged directly beneath the orifice until the vessel is filled with core material particles. Then, the core material surfaces are smoothly scraped out in a single action along the top edge of the vessel using a nonmagnetic horizontal paddle. When core material particles are hardly let out from an orifice having a diameter of 2.5 mm, core material particles are naturally let out from an orifice having a diameter of 5 mm. It is possible to determine the mass of the core material particles per 1 cm³ by dividing the mass of the core material particles poured into the vessel by the volume of the vessel 25 cm³.

In the present invention, the ratio (ρp/ρb) of the particle density of the core material particles (ρp) relative to the bulk density (ρb) of the core material particles is preferably 1.6 to 1.9, and more preferably 1.7 to 1.9. When the ratio (ρp/ρb) is more than 1.9, carrier spent by a toner easily occurs, and the temporal charge ability may be easily degraded. When the ratio (ρp/ρb) is more than 1.6 or more, it is possible to obtain a desired value without spending a large amount of money.

For the core material particles, crushed particles of a magnetic material can be used. When core material particles are made of ferrite or magnetite, primarily granulated product of pre-sintered particles are classified and sintered, and the sintered particles are then classified into particulate powders having different particle size distributions, and a plurality of particulate powders are mixed, thereby obtaining core material particles.

The method of classifying the core material particles is not particularly limited, may be suitably selected in accordance with the intended use, and examples thereof include sieve machines, gravity classifiers, centrifugal classifiers, and inertial classifiers. Of these, wind-force classifiers such as gravity classifiers, centrifugal classifiers, and inertial classifiers are particularly preferable.

The core material particles are not particularly limited, may be suitably selected in accordance with the intended use, and examples thereof include ferromagnetic materials such as iron and cobalt; magnetite, hematite, Li ferrite, Mn—Zn ferrite, Cu—Zn ferrite, Ni—Zn ferrite, Ba ferrite, and Mn ferrite.

The ferrite is a sinter represented by the general formula of (MO) x (NO) y (Fe₂O₃)z. In the general formula, x, y, and z respectively a composition of the used ferrite, and examples of M and N individually include Ni, Cu, Zn, Li₂, Mg, Mn, Sr, and Ca and are respectively constituted by a complete mixture between a metal oxide and an iron oxide (III).

<Coating Layer>

The coating layer contains at least a binder resin, an aminosilane coupling agent, and hard particles and further contains other components in accordance with the necessity.

—Binder Resin—

For the binder resin, a silicone resin is preferably used. The silicone resin is not particularly limited and may be suitably selected from among generally known silicone resins in accordance with the intended use, however, a silicone resin containing at least one of repeat units represented by the following general formulas.

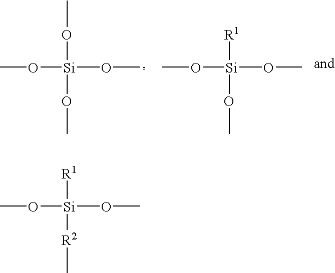

In the general formulas, R¹ represents an hydrogen atom, a halogen atom, a hydroxyl group, a methoxyl group, a lower alkyl group having 1 to 4 carbon atoms or an aryl group (for example, phenyl group, and tolyl group); and R² represents an alkylene group having 1 to 4 carbon atoms or an arylene group (for example, phenylene group).

Examples of the alkyl group include methyl groups, ethyl groups, propyl groups, and butyl groups.

Examples of the alkylene group include methylene groups, ethylene groups, propylene groups, and butylene groups.

The number of carbon atoms of the aryl group is preferably 6 to 20, and more preferably 6 to 14. Examples of the aryl groups include, besides benzene-derived aryl groups (phenyl groups), condensation polycyclic aromatic hydrocarbon-derived aryl groups such as naphthalene, phenanthrene, and anthracenes; and chained polycyclic aromatic hydrocarbon-derived aryl groups such as biphenyl and terphenyl. The aryl groups may be substituted by various substituent groups.

The number of carbon atoms of the arylene group is preferably 6 to 20, and more preferably 6 to 14. Examples of the arylene groups include, besides benzene-derived arylene groups (phenyl groups), condensation polycyclic aromatic hydrocarbon-derived arylene groups such as naphthalene, phenanthrene, and anthracenes; and chained polycyclic aromatic hydrocarbon-derived arylene groups such as biphenyl and terphenyl. The arylene groups may be substituted by various substituent groups.

Preferred examples of the silicone resin include, besides the above mentioned, straight silicone resins made from only an organosiloxane bond, and modified silicone resins.

Specific examples of the straight silicone resin include KR271, KR272, KR282, KR252, KR255, and KR 152 (all manufactured by Shin-Etsu Chemical Co., Ltd.); and SR2400, SR2406, and SR2411 (all manufactured by DOW CORNING TORAY SILICONE CO., LTD.).

Examples of the modified silicone resin include epoxy-modified silicone resins, acrylic-modified silicone resins, phenol-modified silicone resins, urethane-modified silicone resins, polyester-modified silicone resins, alkyd-modified silicone resins. Specific examples of the epoxy-modified silicone resin include ES-1001N (manufactured by Shin-Etsu Chemical Co., Ltd.) and SR2115 (manufactured by DOW CORNING TORAY SILICONE CO., LTD.). Examples of the acrylic-modified silicone resins include KR-5203 (manufactured by Shin-Etsu Chemical Co., Ltd.). Examples of the alkyd-modified silicone resin include KR-206 (manufactured by Shin-Etsu Chemical Co., Ltd.) and SR2110 (manufactured by DOW CORNING TORAY SILICONE CO., LTD.). Examples of the urethane-modified silicone resin include KR-305 (manufactured by Shin-Etsu Chemical Co., Ltd.).

For the binder resin, those generally used as a carrier coating resin may also be used in accordance with the necessity, besides the above mentioned resins. Examples of the binder resin include polystyrene, polychlorostyrene, poly(α-methylstyrene), styrene-chlorostyrene copolymers, styrene-propylene copolymers, styrene-butadiene copolymers, styrene-vinylchloride copolymers, styrene-vinylacetate copolymers, styrene-maleic acid copolymers, styrene-acrylic acid ester copolymers (such as styrene-methyl acrylate copolymer, styrene-ethyl acrylate copolymer, styrene-butyl acrylate copolymer, styrene-octyl acrylate copolymer, and styrene-phenyl acrylate copolymer); styrene-methacrylic acid ester copolymers (such as styrene-methyl methacrylate copolymer, styrene-ethyl methacrylate copolymer, styrene-butyl methacrylate copolymer, and styrene-phenyl methacrylate copolymer); styrene resins such as styrene-α-chloromethyl acrylate copolymers, styrene-acrylonitrile-acrylic acid ester copolymers; epoxy resins, polyester resins, polyethylene, polypropylene, ionomer resins, polyurethane resins, ketone resins, acrylic resins, ethylene-ethyl acrylate copolymers, xylene resins, polyamide resins, phenol resins, polycarbonate resins, melamine resins, and fluorine resins. Each of these binder resins may be used alone or in combination with two or more.

—Aminosilane Coupling Agent—

The coating layer preferably contains an aminosilane coupling agent. When the coating layer contains an aminosilane coupling agent, a carrier having excellent durability can be obtained. Examples of the aminosilane coupling agent include compounds represented by the following formulas.
H₂N(CH₂)₃Si(OCH₃)₃
H₂N(CH₂)₃Si(OC₂H₅)₃
H₂N(CH₂)₃Si(CH₃)₂(OC₂H₅)
H₂N(CH₂)₃Si(CH₃)(OC₂H₅)₂
H₂N(CH₂)₂NHCH₂Si(OCH₃)₃
H₂N(CH₂)₂NH(CH₂)₃Si(CH₃)(OCH₃)₂
H₂N(CH₂)₂NH(CH₂)₃Si(OCH₃)₃
(CH₃)₂N(CH₂)₃Si(CH₃)(OC₂H₅)₂
(C₄H₉)₂N(CH₂)₃Si(OCH₃)₃

The content of the aminosilane coupling agent in the coating layer is preferably 0.001% by mass to 30% by mass, and more preferably 0.5% by mass to 10% by mass. When the content is less than 0.001% by mass, the charge property is easily affected by environmental conditions, and the production yield may be easily lowered. When the content of the aminosilane coupling agent is more than 30% by mass, the coated resins is readily brittle, and the abrasion resistance of the coating layer may be degraded.

—Hard Particles—

To reinforce the coating layer, it is preferred that hard particles be contained in the coating layer. For the hard particles, particles containing a metal oxide are particularly preferable because metal oxide particles have highly uniform particle diameters, allow obtaining high affinity with components of the coating layer, and have a profound reinforcement effect of the coating layer. Examples of particles containing a metal oxide include particles containing a Si oxide, particles containing a Ti oxide, and particles containing an Al oxide. Each of these metal oxide particles may be used alone or in combination with two or more. For the hard particles, it is possible to use all hard particles, for example, those that are not been subjected to a surface treatment and those that have been subjected to a surface treatment such as hydrophobization treatment.

The content of the hard particles in the coating layer is preferably 2% by mass to 70% by mass, and more preferably 5% by mass to 40% by mass. The content of the hard particles may be suitably adjusted depending on the particle diameter and the specific surface area, however, when the content of the hard particles is less than 2% by mass, the effect of improving the abrasion resistance relative to the coating layer may be hardly exhibited. When the content thereof is more than 70% by mass, hard particles are easily detached from the coating layer, and the temporal charge property may be degraded.

The method for forming a coating layer on surfaces of the core material particles is not particularly limited, may be suitably selected in accordance with the intended use, however, examples thereof include spray-dry method, immersion method, and power-coating method. Of these, a method using a fluidized bed coating apparatus is particularly effective in forming a uniform coating layer.

The thickness of the coating layer exposed as surfaces of the core material particles is preferably 0.02 pim to Ilim, and more preferably 0.03 μm to 0.8 μm. The thickness of the coating layer is extremely thinner than the particle diameter of the core material particles, and thus the particle diameter of the carrier with a coating layer formed on the surface thereof is substantially equal to those of the core material particles.

The weight average particle diameter (Dw) of the carrier is preferably 22 μm to 32 μm, and more preferably 23 μm to 30 μm. When the weight average particle diameter (Dw) is more than 32 μm, carrier adhesion rarely occurs, however, the toner is not developed truly to a latent image, variations in dot diameter may be increased, and the granularity may be degraded. In addition, when the toner density is increased, background smear may easily occur. Carrier adhesion represents phenomena that carrier particles adhere to image portions and/or background portions of a latent electrostatic image. At this point in time, the stronger the applied electric field is, the easier carrier adhesion occurs. The electric field is weakened at image portions because image portions are developed using a toner, and image portions more hardly induce carrier adhesion than at background portions. Occurrences of carrier adhesion are unfavorable because they lead to troubles of causing flaws on photoconductors and fixing rollers, etc.

The ratio (Dw/Dp) between the number average particle diameter (Dp) and the weight average particle diameter (Dw) is preferably 1.0 to 1.2. When the ratio (Dw/Dp) is more than 1.2, the ratio of fine particles is increased, and the resistance to carrier adhesion may be degraded.

The content of carrier particles having a particle diameter of 0.02 μm to 20 μm is preferably 0% by mass to 7% by mass, more preferably 0.5% by mass to 5% by mass, and still more preferably 0.5% by mass to 3% by mass. When the content of carrier particles having a particle diameter of 0.02 μm to 20 μm is more than 7% by mass, the particle diameter distribution is widen, and particles having a small magnetic moment may reside in magnetic brush, and this may cause occurrences of carrier adhesion.

The content of carrier particles having a particle diameter of 0.02 μm to 36 μm is preferably 90% by mass to 100% by mass, and more preferably 92% by mass to 100% by mass. By narrowing the particle size distribution of the carrier coated with a resin, the magnetic moment distribution of individual particles can be narrowed, and the occurrences of carrier adhesion can be drastically reduced.

Here, the particle size distribution, the number average particle diameter (Dp), and the weight average particle diameter (Dw) of the carrier are calculated based on the particle size distribution of particles measured on a number basis i.e. the relation between the number based frequency and the particle diameter, and are respectively represented by the following equations.
Dp={1/Σ(n)}×{Σ(nD)}
Dw={1/Σ(nD³)}×{Σ(nD⁴)}

Here, D represents a typical particle diameter (μm) of particles residing in each channel, and “n” represents the number of particles residing in each channel. It should be noted that each channel is a length for equally dividing the scope of particle diameters in the particle size distribution chart, and 2 μm can be employed for each channel in the present invention. For the typical particle diameter of particles residing in each channel, the lower limit value of particle diameters of the respective channels can be employed. For a particle size analyzer used for measuring the particle size distribution, a micro track particle size analyzer (Model HRA9320-X100, manufactured by Honewell Corp.) can be used.

The magnetic moment (magnetization) when a magnetic field of 1 kOe is applied to the carrier is preferably 50 emu/g to 150 emu/g, and more preferably 65 emu/g to 120 emu/g. With this configuration, occurrences of carrier adhesion can be prevented. When the magnetization of carrier is lower than 50 emu/g, carrier adhesion may easily occur.

The magnetization of the carrier can be measured by the following procedures, using, for example, B-H tracer (BHU-60 manufactured by Riken Denshi Co., Ltd.).

First, 1 g of core material particles is packed in a cylindrical cell, and the cylindrical cell is set to a magnetization measurement device. The magnetic field is gradually increased up to 3 kOe, and then the magnetic field is gradually reduced to zero, and the opposite magnetic field is gradually increased up to 3 kOe. Then, the opposite magnetic filed is gradually reduced to zero, and a magnetic field is applied in the same direction as the initially applied direction. In this way, a B—H curve is prepared to calculate the magnetization of 1 kOe based on the B—H curve.

(Developer)

The developer of the present invention contains the carrier of the present invention and a toner.

The mixture ratio of the toner and the carrier in the developer is preferably 2 parts by mass to 25 parts by mass of the toner relative to 100 parts by mass of the carrier, and more preferably 3 parts by mass to 20 parts by mass of the toner relative to 100 parts by mass of the carrier.

<Toner>

The toner contains a binder resin, a colorant, fine particles, a charge controlling agent, and a releasing agent, and further contains other components in accordance with the necessity.

The toner can be produced using a production method such as polymerization method and granulation method, and a nonuniformly shaped toner or a spherically shaped toner can be obtained. Any of a magnetic toner and a nonmagnetic toner can be used.

—Binder Resin—

The binder resin is not particularly limited and may be suitably selected in accordance with the intended use. Examples thereof include styrene or substitution polymers thereof such as polystyrene, and polyvinyl toluene; styrene-p-chlorostyrene copolymers, styrene-propylene copolymers, styrene-vinyltoluene copolymers, styrene-methyl acrylate copolymers, styrene-ethyl acrylate copolymers, styrene-butyl acrylate, styrene-methyl methacrylate copolymers, styrene-ethyl methacrylate copolymers, styrene-butyl methacrylate copolymers, styrene-α-chloromethyl methacrylate copolymers, styrene-acrylonitrile copolymers, styrene-vinyl methyl ether copolymers, styrene-vinyl methyl ketone copolymers, styrene-butadiene copolymers, styrene-isoprene copolymers, styrene-maleic acid copolymers, styrene-maleic acid ester copolymers, methyl polymethacrylate, butyl polymethacrylate, polyvinyl chloride, polyvinyl acetate, polyethylene, polypropylene, polyester resin, polyurethane, epoxy resin, polyvinyl butyral, polyacrylic acid resins, rosins, modified rosins, terpene resins, phenol resins, alicyclic or aliphatic hydrocarbon resins, aromatic petroleum resins, chlorinated paraffins, and paraffin waxes. Each of these binder resins may be used alone or in combination with two or more. Of these, polyester resins are particularly preferable in terms that the melt viscosity can be reduced while ensuring the storage stability of a toner as compared to styrene resins and acrylic resins.

The polyester resin can be obtained by a polycondensation reaction between, for example, an alcohol component and a carboxylic acid component.

Examples of the alcohol component include polyethylene glycol, diethylene glycol, triethylene glycol, 1,2-propylene glycol, 1,3-propylene glycol, 1,4-propylene glycol, neopentyl glycol, diols such as 1,4-butene diol; etherified bisphenols such as 1,4-bis(hydroxymethyl) cyclohexane, bisphenol A, hydrogenated bisphenol A, polyoxy-ethylenated bisphenol A, polyoxy-propylenated bisphenol A; divalent alcohol monomers in which each of the above-noted alcohol components is substituted by a saturated or unsaturated hydrocarbon group having 3 to 22 carbon atoms, other divalent alcohol monomers; and trivalent or more high-alcohol monomers such as sorbitol, 1,2,3,6-hexane tetrol, 1,4-sorbitan, pentaerythritol, dipentaerythritol, tripentaerythritol, sucrose, 1,2,4-butanetriol, 1,2,5-pentanetriol, glycerol, 2-methylpropane triol, 2-methyl-1,2,4-butanetriol, trimethylol ethane, trimethylol propane, and 1,3,5-trihydroxymethyl benzene.

Examples of the carboxylic acid component include monocarboxylic acids such as palmitic acid, stearic acid, and oleic acid; maleic acid, fumaric acid, mesaconic acid, citraconic acid, terephthalic acid, cyclohexane dicarboxylic acid, succinic acid, adipic acid, sebacic acid, malonic acid; divalent organic acid monomers that each of the above-noted carboxylic acid components is substituted by a saturated or unsaturated hydrocarbon group having 3 to 22 carbon atoms; anhydrides thereof; dimer acids containing a lower alkyl ester and a linolenic acid; 1,2,4-benzene tricarboxylic acid, 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 3,3-dicarboxy methyl butane acid, tetracarboxy methyl methane; 1,2,7,8-octanetetracarboxylic enball trimer acid, and trivalent or more polyvalent carboxylic acid monomers such as anhydrides of these acids.

For the epoxy resin, a polycondensation product between bisphenol A and epichlorohydrin etc, can be used, and specific examples of commercially available epoxy resins include Epomic R362, R364, R365, R366, R367, and R369 (all manufactured by MITSUI OIL CO., LTD.); Epotote YD-011, YD-012, YD-014, YD-904, and YD-017 (all manufactured by Tohto Kasei Co., Ltd.); and Epocoat 1002, 1004, and 1007 (all manufactured by Shell Chemicals Japan Ltd.).

—Colorant—

The colorant is not particularly limited and may be suitably selected from among dyes and pigments known in the art. Examples thereof include carbon black, nigrosine dye, iron black, naphthol yellow S, Hansa yellow (10 G, 5G, and G), cadmium yellow, yellow iron oxide, yellow ocher, yellow lead, titanium yellow, polyazo yellow, oil yellow, Hansa yellow (GR, A, RN, R), pigment yellow L, benzidine yellow (G, GR), permanent yellow (NCG), vulcan fast yellow (5G, R), tartrazinelake yellow, quinoline yellow lake, anthraene yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL, F4RH), fast scarlet VD, vulcan fast rubin B, brilliant scarlet G, lithol rubin GX, permanent red F5R, brilliant carmin 6B, pigment scarlet 3B, bordeaux 5B, toluidine Maroon, permanent bordeaux F2K, Hello bordeaux BL, bordeaux 10B, BON maroon light, BON maroon medium, eosin lake, rhodamine lake B, rhodamine lake Y, alizarin lake, thioindigo red B, thioindigo maroon, oil red, quinacridon red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS, BC), indigo, ultramarine, iron blue, anthraquinon blue, fast violet B, methylviolet lake, cobalt purple, manganese Violet, dioxane violet, anthraquinon violet, chrome green, zinc green, chromium oxide, viridian green, emerald green, pigment green B, naphthol green B, green gold, acid green lake, malachite green lake, phthalocyanine green, anthraquinon green, titanium oxide, zinc flower, and lithopone.

Each of these colorants may be used alone or in combination with two or more.

The dyes are not particularly limited and may be suitably selected in accordance with the intended use. Specific examples thereof include C.I. SOLVENT YELLOW (6, 9, 17, 31, 35, 100, 102, 103, and 105); C.I. SOLVENT ORANGE (2, 7, 13, 14, and 66); C.I.SOLVENT RED (5, 16, 17, 18, 19, 22, 23, 143, 145, 146, 149, 150, 151, 157, and 158); C.I. SOLVENT VIOLET (31, 32, 33, and 37); C.I. SOLVENT BLUE (22, 63, 78, 83, 84, 85, 86, 191, 194, 195, and 104); C.I.SOLVENT GREEEN (24, and 25); and C.I. SOLVENT BROWN (3, and 9).

In addition, the commercially available dyes are not particularly limited, may be suitably selected in accordance with the intended use, and it is possible to use Aizen SOT dyes of Yellow-1, 3, 4, Orange-1, 2, 3, Scarlet-1, Red-1, 2, 3, Brown-2, Blue-1, 2, Violet-1, Green-1, 2, 3, Black-1, 4, 6, 8 manufactured by Hodogaya Chemical Co.; Sudan dyes of Yellow-146, 150, 0 range-220, Red-290, 380, 460, Blue-670 manufactured by BASF; Diaresin of Yellow-3 G, F, H2 G, HG, HC, HL, Orange-HS, G, Red-GG, S, HS, A, K, H5B, Violet-D, Blue-J, G, N, K, P. H3 G, 4 G, Green-C, Brown-A manufactured by Mitsubishi Chemical Corp.; OIL COLOR Yellow-3 G, GG-S, #105, Orange-PS, PR, #201, Scarlet-#308, Red-5B, Brown-GR, #416, Green-BG, #502, Blue-BOS, IIN, Black-HBB, #803, EB, and EX manufactured by Orient Chemical Industries, Ltd.; SUMIPLAST BLUE GP, OR, RED FB, 3B, Yellow FL7 G, GC manufactured by Sumitomo Chemical Co., Ltd.; and Kayalon Polyester Black EX-SF300, Kayaset Red-B, and Blue A-2R manufactured by Nippon Kayaku Co., Ltd.

The added amount of the colorant is not particularly limited and may be suitably adjusted in accordance with the degree of pigmentation, however, it is preferably 1 part by mass to 50 parts by mass relative to 100 parts by mass of the binder resin.

—Charge Controlling Agent—

The charge controlling agent is not particularly limited and may be suitably selected from among those known in the art, however, it is preferable to use a colorless charge controlling agent or a charge controlling agent being close to white color because the color tone may be changed when a colored material is used. Examples of the colorless controlling agent or the controlling agent being close to white color include nigrosine dyes, triphenyl methane dyes, chrome-containing metal complex dyes, molybdate chelate pigments, Rhodamine dyes, alkoxy amine, quaternary ammonium salt (including fluorine-modified quaternary ammonium salt), alkyl amide, phosphorous monomers or compounds thereof, tungsten monomers or compounds thereof, fluorine activators, metal salts of salicylic acid, and metal salts of salicylic acid derivatives. Of these, metal salts of salicylic acid and metal salts of salicylic acid derivatives are preferable. Each of these charge controlling agents may be used alone or in combination with two or more. The metal is not particularly limited, may be suitably selected in accordance with the intended use, and examples thereof include aluminum, zinc, titanium, strontium, boron, silicon, nickel, iron, chrome, and zirconium.

For the charge controlling agent, a commercially available one may be used, and examples of the commercially available charge controlling agent include BONTRON P-51 of a quaternary ammonium salt, E-82 of an oxynaphthoic acid metal complex, E-84 of a salicylic acid metal complex, and E-89 of a phenol condensation product (all manufactured by Orient Chemical Industries, Ltd.); TP-302 or TP-415 of a molybdenum complex of quaternary ammonium salt (all manufactured by Hodogaya Chemical Co.); Copy Charge PSY VP2038 of a quaternary ammonium salt, Copy Blue PR of a triphenyl methane derivative, and Copy Charge NEG VP2036 of a quaternary ammonium salt or Copy Charge NX VP434 (all manufactured by Hochst Corporation); LRA-901, and LR-147 of a boron complex (manufactured by Japan Carlit Co., Ltd.); quinacridone; azo pigments; and high-molecular compounds having a functional group such as sulfonic acid group, and carboxyl group.

The added amount of the charge controlling agent is not particularly limited and may be suitably adjusted in accordance with the intended use, however, it is preferably 0.5 parts by mass to 5 parts by mass relative to 100 parts by mass of the resin fine particles, and more preferably 1 part by mass to 3 parts by mass relative to 100 parts by mass of the resin fine particles. When the added amount of the charge controlling agent is less than 0.5 parts by mass, the charge property of the toner may be degraded, and when the added amount is more than 5 parts by mass, the charge property of the toner is excessively increased, and the excessively increased charge property of the toner impairs the effect of the main charge controlling agent to increase the electrostatic attraction force between the toner and developing rollers, and this may cause degradation of flowability of the developer and degradation of image density.

—Releasing Agent—

The releasing agent is not particularly limited, may be suitably selected from among those known in the art in accordance with the intended use, and preferred examples thereof include waxes.

Examples of the waxes include low-molecular weight polyolefin waxes, synthesized hydrocarbon waxes, natural waxes, petroleum waxes, higher fatty acids and metal salts thereof, higher fatty acid amides, and various modified waxes. Each of these waxes may be used alone or in combination with two or more.

Examples of the low molecular weight polyolefin waxes include low molecular weight polyethylene waxes, and low-molecular weight polypropylene waxes.

Examples of the synthesized hydrocarbon waxes include Fisher Tropsh wax.

Examples of the natural waxes include bees waxes, carnauba wax, Candellila wax, rice wax, and montan wax.

Examples of the petroleum waxes include paraffin waxes, and micro crystalline waxes.

Examples of the higher fatty acids include stearic acids, palmitic acids, and myristic acids.

The added amount of the releasing agent is not particularly limited and may be suitably selected in accordance with the intended use, however, it is preferably 1 part by mass to 20 parts by mass relative to 100 parts by mass of the resin fine particles, and more preferably 3 parts by mass to 15 parts by mass.

A magnetic toner contains a magnetic material. For the magnetic material, it is possible to use a ferromagnetic material such as iron and cobalt or fine particles such as magnetite fine particles, hematite fine particles, Li ferrite fine particles, Mn—Zn ferrite fine particles, Cu—Zn ferrite fine particles, Ni—Zn ferrite fine particles, and Ba ferrite fine particles.

The toner may contain other additives. To obtain a high-quality image, it is preferable to impart flowability to a toner. To impart flowability to the toner, it is typically effective to add particles such as hydrophobized metal oxide particles, lubricant particles, etc. as a flowability improving agent, and particles, for example, of a metal oxide, a resin, a metal soap, etc. can be used as additives. Specific examples of the additives include fluorine resins such as polytetrafluoroethylene; lubricants such as zinc stearate, abrasives such as cerium oxide, silicon carbide; flowability imparting agents, for example, an inorganic oxide such as SiO₂ and TiO₂ that the surface thereof has been hydrophobized; caking inhibitors known in the art; and materials that have been subjected to a surface treatment. To improve flowability of a toner, a hydrophobized silica is particularly preferably used.

The weight average particle diameter of the toner is preferably 3.0 μm to 9.0 μm, and more preferably 3.5 μm to 7.5 μm. The weight average particle diameter of the toner can be measured by using, for example, Coulter Counter (manufactured by Coulter Electronics Ltd).

(Process Cartridge)

The process cartridge of the present invention has at least a photoconductor and a developing unit configured to develop a latent electrostatic image formed on the photoconductor using the developer of the present invention to form a visible image, and can be detachably attached to a body of an image forming apparatus. The process cartridge may be further integrally provided with a charging unit configured to charge the surface of the photoconductor such as a charge brush; and a cleaning unit such as a blade which is configured to remove a residual developer remaining on the photoconductor surface.

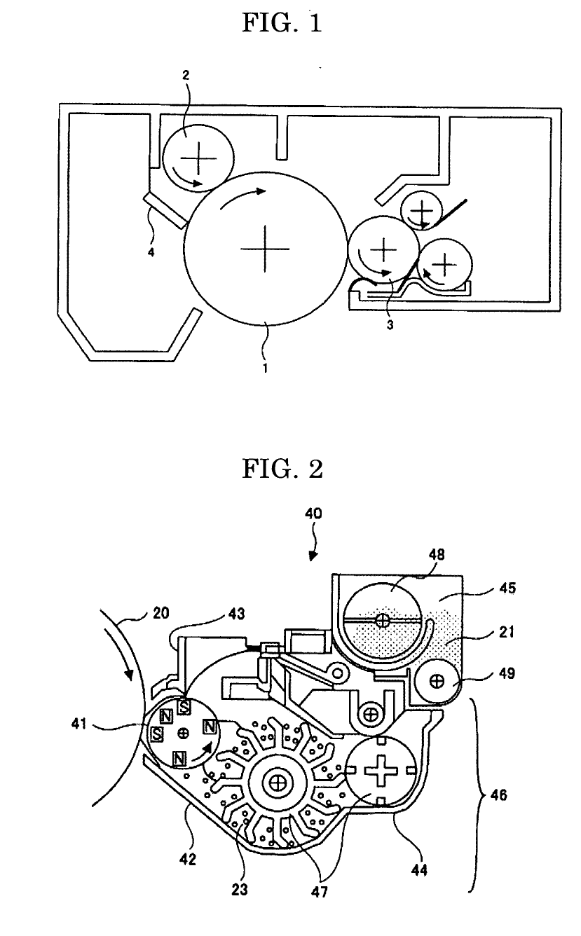

FIG. 1 is a view schematically showing one example of a process cartridge of the present invention. The process cartridge shown in FIG. 1 is integrally composed of a photoconductor 1, a charging unit 2, an image developing apparatus 3, and a cleaner 4, and is detachably attached to a body of an image forming apparatus such as a copier and a printer. The developer of the present invention is used for developing an image.

(Image Forming Method and Image Forming Apparatus)

The image forming method of the present invention includes at a least latent electrostatic image forming step, a developing step, a transferring step, and a fixing step and further includes other steps suitably selected in accordance with the necessity such as a charge elimination step, a cleaning step, a recycling step, and a controlling step.

The image forming apparatus of the present invention is provided with at least a photoconductor, a latent electrostatic image forming unit, a developing unit, a transferring unit, and a fixing unit and is further provided with other units suitably selected in accordance with the necessity such as a charge elimination unit, a cleaning unit, a recycling unit, and a controlling unit.

The latent electrostatic image forming step is a step in which a latent electrostatic image is formed on a photoconductor.

The photoconductor (may be referred to as “electrophotographic photoconductor”, “late electrostatic image bearing member” or “latent image bearing member”) is not particularly limited as to the material, shape, structure, size, or the like, and may be suitably selected from among those known in the art. With respect to the shape of the photoconductor, drum-shaped one is preferably used. Preferred examples of the material include inorganic photoconductors made from amorphous silicon, selenium, or the like, and organic photoconductors made of polysilane, phthalopolymethine, or the like. Among these materials, amorphous silicons or the like are preferably used in terms of longer operating life.

The latent electrostatic image can be formed, for example, by charging the surface of the photoconductor uniformly and then exposing the surface thereof imagewisely by means of the latent electrostatic image forming unit. The latent electrostatic image forming unit is provided with, for example, at least a charger configured to uniformly charge the surface of the photoconductor, and an exposer configured to expose the surface of the photoconductor imagewisely.

The surface of the photoconductor can be charged by applying a voltage to the surface of the photoconductor through the use of, for example, the charger.

The charger is not particularly limited, may be suitably selected in accordance with the intended use, and examples thereof include contact chargers known in the art, for example, which are equipped with a conductive or semi-conductive roller, a brush, a film, a rubber blade or the like, and non-contact chargers utilizing corona discharge such as corotoron and scorotoron.

The surface of the photoconductor can be exposed, for example, by exposing the photoconductor surface imagewisely using the exposer.

The exposer is not particularly limited, provided that the surface of the photoconductor which has been charged by the charger can be exposed imagewisely, may be suitably selected in accordance with the intended use, and examples thereof include various types of exposers such as reproducing optical systems, rod lens array systems, laser optical systems, and liquid crystal shutter optical systems.

In the present invention, the back light method may be employed in which exposing is performed imagewisely from the back side of the photoconductor.

—Developing and Developing Unit—

The developing step is a step in which the latent electrostatic image is developed using the developer of the present invention to form a visible image.

The visible image can be formed by developing the latent electrostatic image using, for example, the developer in the developing unit.

The developing unit is not particularly limited, as long as a latent electrostatic image can be developed using the developer of the present invention, may be suitably selected from those known in the art, and preferred examples thereof include the one having at least an image developing apparatus which houses the developer of the present invention therein and enables supplying the developer to the latent electrostatic image in a contact or a non-contact state.

The image developing apparatus may employ a dry-developing process or a wet-developing process. It may be a monochrome color image developing apparatus or a multi-color image developing apparatus. Preferred examples thereof include the one having a stirrer by which the developer is frictionally stirred to be charged, and a rotatable magnet roller.

In the image developing apparatus, for example, a toner and the carrier are mixed and stirred, the toner is charged by frictional force at that time to be held in a state where the toner is standing on the surface of the rotating magnet roller to thereby form a magnetic brush. Since the magnet roller is located near the photoconductor, a part of the toner constituting the magnetic brush formed on the surface of the magnet roller moves to the surface of the photoconductor by electric attraction force. As the result, the latent electrostatic image is developed using the toner to form a visible toner image on the surface of the photoconductor.

—Transferring and Transferring Unit—

In the transferring step, the visible image is transferred onto a recording medium, and it is preferably an aspect in which an intermediate transfer member is used, the visible image is primarily transferred to the intermediate transfer member and then the visible image is secondarily transferred onto the recording medium. An embodiment of the transferring step is more preferable in which two or more color toners are used, an embodiment of the transferring is still more preferably in which a full-color toner is used, and the embodiment includes a primary transferring in which the visible image is transferred to an intermediate transfer member to form a composite transfer image thereon, and a secondary transferring in which the composite transfer image is transferred onto a recording medium.

The transferring can be performed, for example, by charging a visible image formed on the surface of the photoconductor using a transfer-charger to transfer the visible image, and this is enabled by means of the transferring unit. For the transferring unit, it is preferably an embodiment which includes a primary transferring unit configured to transfer the visible image to an intermediate transfer member to form a composite transfer image, and a secondary transferring unit configured to transfer the composite transfer image onto a recording medium.

The intermediate transfer member is not particularly limited, may be suitably selected from among those known in the art in accordance with the intended use, and preferred examples thereof include transferring belts.

The transferring unit (the primary transferring unit and the secondary transferring unit) preferably includes at least an image-transferer configured to exfoliate and charge the visible image formed on the photoconductor to transfer the visible image onto the recording medium. For the transferring unit, there may be one transferring unit or two or more transferring units.

Examples of the image transferer include corona image transferers using corona discharge, transferring belts, transfer rollers, pressure transfer rollers, and adhesion image transfer units.

The recording medium is not particularly limited and may be suitably selected from among those known in the art.

—Fixing and Fixing Unit—

The fixing step is a step in which a visible image which has been transferred onto a recording medium is fixed using a fixing apparatus, and the image fixing may be performed every time each color toner is transferred onto the recording medium or at a time so that each of individual color toners are superimposed at the same time.

The fixing apparatus is not particularly limited, may be suitably selected in accordance with the intended use, and heat-pressurizing units known in the art are preferably used. Examples of the heat-pressurizing units include a combination of a heat roller and a pressurizing roller, and a combination of a heat roller, a pressurizing roller, and an endless belt.

The heating temperature in the heat-pressurizing unit is preferably 80° C. to 200° C.

In the present invention, for example, an optical fixing apparatus known in the art may be used in the fixing step and the fixing unit or instead of the fixing unit.

—Charge Elimination and Charge Elimination Unit—

The charge elimination step is a step in which charge is eliminated by applying a charge-eliminating bias to the photoconductor, and it can be suitably performed by means of a charge-eliminating unit.

The charge-eliminating unit is not particularly limited as long as a charge-eliminating bias can be applied to the latent electrostatic image bearing member, and may be suitably selected from among charge-eliminating units known in the art. For example, a charge-eliminating lamp or the like is preferably used.

—Cleaning and Cleaning Unit—

The cleaning step is a step in which a residual electrographic toner remaining on the photoconductor is removed, and the cleaning can be preferably performed using a cleaning unit.

The cleaning unit is not particularly limited, provided that the residual electrophotographic toner remaining on the photoconductor can be removed, and may be suitably selected from among those known in the art. Examples of the cleaning unit include magnetic brush cleaners, electrostatic brush cleaners, magnetic roller cleaners, blade cleaners, brush cleaners, and web cleaners.

The recycling step is a step in which the toner that had been eliminated in the cleaning is recycled in the developing, and the recycling can be suitably performed by means of a recycling unit.

The recycling unit is not particularly limited, and examples thereof include carrying units known in the art.

Next, the image forming method and the image forming apparatus of the present invention will be described in detail referring to drawings, however, these examples are described for explaining the present invention and are not intended to limit the scope of the present invention.

FIG. 2 is a view schematically showing one example of an image developing apparatus used in the present invention, and modified examples which will be hereinafter described are also included within the spirit and scope of the present invention. In FIG. 2, an image developing apparatus 40 arranged so as to face a photoconductor 20, and the image developing apparatus 40 is primarily composed of a developing sleeve 41 serving as a developer bearing member, a developer housing member 42, a doctor blade 43 serving as a controlling member, and a support case 44.

To the support case 44 which has an aperture on the side of the photoconductor 20, a toner hopper 45 serving as a toner housing part for housing a toner 21 inside thereof is fitted. In a developer housing part 46 which is located adjacent to the toner hopper 45 and is configured to house a developer containing the toner and a carrier 23, a developer agitating mechanism 47 is provided, and the developer agitating mechanism 47 serves to agitate the toner 21 and the carrier 23 as well as to give a frictional charge or a stripping charge to the toner.

Inside the toner hopper 45, a toner agitator 48 as a toner supplying unit which is rotated by a driving unit (not shown), and a toner supplying mechanism 49 are arranged. The toner agitator 48 and the toner supplying mechanism 49 are configured to send the toner 21 residing in the toner hopper 45 toward the developer housing part 46 while agitating the toner 21.

In a space between the photoconductor 20 and the toner hopper 45, the developing sleeve 41 is arranged. The developing sleeve 41 which is driven to rotate in the direction indicated by the arrow in the figure by means of a driving unit (not shown) has a magnet (not shown) serving as a magnetic field generating unit which is inalterably located at a relative position to the image developing apparatus 40 inside of the developing sleeve 41.

The doctor blade 43 is integrally attached to the developer housing member 42 on the opposite position where the developer housing member 42 is attached to the support case 44. The doctor blade 43 is arranged, in this example, in a state where an interspace with a certain distance is kept between the edge of the doctor blade 43 and the outer circumference surface of the developing sleeve 41.

Using such an image developing apparatus in an unlimited manner, the image forming method of the present invention is carried out as follows. The toner 21 sent out from the inside of the toner hopper 45 by action of the toner agitator 48 and the toner supplying mechanism 49 is conveyed to the developer housing part 46. Then, the toner 21 is agitated by means of a developer agitating mechanism 47, and the agitation force gives the toner 21 a desired frictional charge or a stripping charge, and the toner 21 is carried on the developing sleeve 41 together with the carrier 23 as a developer to be conveyed at the opposed position to the outer circumferential surface of the photoconductor 20, and then only the toner 21 is electrostatically bound to a latent electrostatic image formed on the surface of the photoconductor 20 to thereby form a toner image on the photoconductor 20.

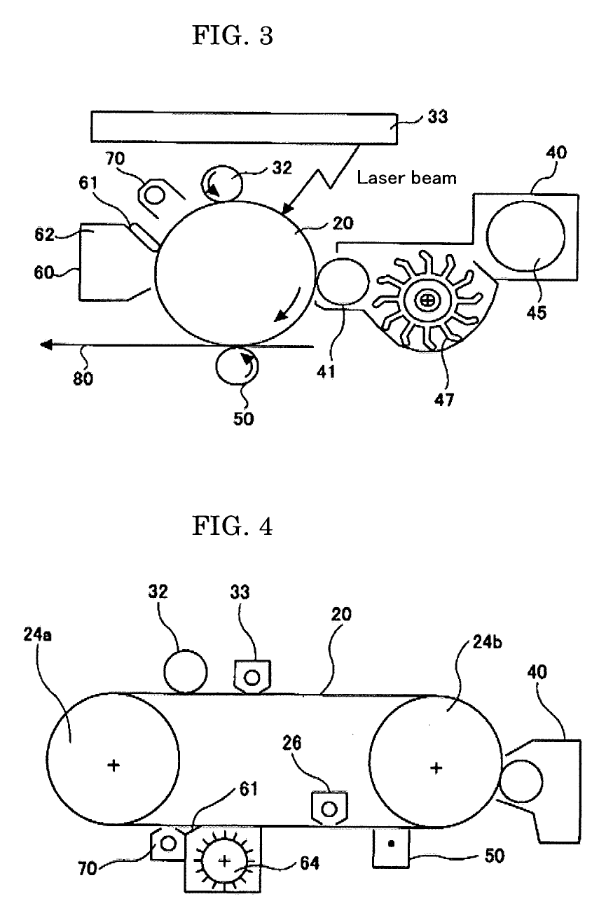

FIG. 3 is a view schematically showing one example of an image forming apparatus equipped with the image developing apparatus shown in FIG. 2. Around the drum-like photoconductor 20, a charge member 32, an image exposing system 33, the image developing apparatus 40, an image transferer 50, a cleaner 60, and a charge elimination lamp 70 are located. In this case, the surface of the charge member 32 is arranged in a noncontact state with the surface of the photoconductor 20 spacing approximately 0.2mm, and when the photoconductor is charged through the use of the charge member 32, the surface of the photoconductor 20 is charged with an electric field in which an alternate current component is superposed to a direct current component by use of a voltage application unit which is not shown in the charge member 32. With this configuration, it is possible to reduce nonuniformity of charge, and the surface of the photoconductor 20 can be effectively charged. The image forming method including a developing method is performed with the following operations.

A series of the image forming process can be explained using a negative-positive process. A photoconductor 20 typified by an organic photoconductor (OPC) having an organic photoconductive layer is charge-eliminated using a charge elimination lamp 70 and is uniformly negatively charged by a charge member 32 such as an electric charger and a charge roller to form a latent image by means of a laser beam applied from an image exposing system 33 such as a laser optical system (in this case, the absolute value of the potential of exposed areas is lower than that of unexposed areas).

The laser beam is emitted from a semiconductor laser to scan the surface of the photoconductor 20 in the direction of the rotational axis of the photoconductor 20 using a polygonal mirror in a shape of polygonal pole, which is rotating at a high speed to form a latent image on the photoconductor surface. The latent image formed in this way is developed using a developer which contains a mixture of a toner and a carrier and is supplied to a developing sleeve 41 serving as a developer bearing member in the image developing apparatus 40 to thereby form a toner image. When a latent image is developed, a developing bias of an appropriate amount of direct current voltage or an alternate current voltage superposed to the direct current voltage is applied from a voltage applying mechanism (not shown) through the developing sleeve 41 to areas in between exposed areas and unexposed areas on the photoconductor 20.

In the meanwhile, a recording medium 80 (for example, paper) is fed and sent from a sheet feeding mechanism (not shown) to be synchronized with the edge of an image at a position of a pair of resist rollers (not shown) to be sent in between the photoconductor 20 and an image transferer 50 to thereby transfer a toner image onto the recording medium 80. At this point in time, it is preferable that an electrical potential of a reverse polarity from the polarity of the toner charge be applied as a transfer bias to the image transferer 50.

Thereafter, the recording medium 80 is separated from the photoconductor 80 to allow obtaining a transferring image.

A residual toner remaining on the photoconductor 20 is collected to a toner collection chamber 62 within a cleaner 60 by action of a cleaning blade 61 as a cleaning member.

The collected toner may be conveyed to a developer housing part (not shown) and/or a toner hopper 45 by action of a toner recycling unit (not shown) to be reused.

The image forming apparatus may be an apparatus in which a plurality of image developing apparatuses described above are arranged to sequentially transfer a toner image onto a recording medium, and the toner image is sent to a fixing mechanism to be fixed by heat, etc., or may be an apparatus in which a plurality of toner images are transferred onto an intermediate recording medium once, and the toner images on the intermediate recording medium are transferred onto a recording medium at a time to be fixed in a similar manner as mentioned above.

FIG. 4 is a view schematically showing another example of an image forming apparatus used in the present invention. A photoconductor 20 is provided with at least a photosensitive layer on a conductive support and is driven by action of driving rollers 24a and 24b. In the image forming apparatus, the surface of the photoconductor is charged by using a charge member 32, an image is exposed on the photoconductor surface by using an image exposing optical system 33, the image is developed by using an image developing apparatus 40, the developed image is transferred onto a recording medium by using an image transferer 50 having a corona charger, pre-cleaning exposure is performed by using a pre-cleaning exposure light source 26, a residual toner is cleaned by using a brush-like cleaning unit 64 and a cleaning blade 61, and the photoconductor surface is charge eliminated by using a charge elimination lamp 70. The above-mentioned process is repeatedly performed. In an image forming apparatus shown in FIG. 4, the photoconductor 20 (in this case, the support is translucent) is subjected to a pre-cleaning exposure treatment from the support side.

### EXAMPLES

Hereafter, the present invention will be further described in detail referring to specific examples, however, the present invention is not limited to the disclosed examples. It should be noted that “part” or “parts” represents “part by mass” or “parts by mass”, and “%” represents “% by mass”.

In the following examples and comparative examples, “thickness of a coating layer”, “particle density of core material particles”, “bulk density of core material particles”, “weight average particle diameter and particle size distribution of the carrier” and “magnetization of the carrier” were measured by the following procedures.

<Average Thickness of Coating Layer>

The average thickness of the coating layer was determined as follows. The prepared carrier was pulverized, and the cross-sectional surface of the carrier was observed using a scanning electron microscope, and the thickness of the coating layer was measured at five sites, and the five measured values were averaged out.

<Particle Density of Core Material Particles>

The particle density of the core material particles was measured using a dry automatic densitometer (ACUPIC 1330 manufactured by Shimadzu Corporation).

<Bulk Density>

The bulk density of the core material particles was measured as follows in accordance with the metal powder-appearance density testing method (JIS Z2504).

First, core material particles were naturally let out from an orifice having a diameter of 2.5 mm, and the core material particles were poured into a stainless cylindrical vessel of 25 cm³ in volume which was located beneath the orifice until the cylindrical vessel was filled with the core material particles. Then, the core material surfaces were smoothly scraped out in a single action along the top edge of the vessel using a nonmagnetic horizontal paddle. When core material particles were hardly let out from an orifice having a diameter of 2.5 mm, core material particles were naturally let out from an orifice having a diameter of 5 mm. The mass of the core material particles per 1 cm³ by dividing the mass of the core material particles poured into the vessel by the volume of the vessel 25 cm³.

<Weight Average Particle Diameter (Dw), Number Average Particle Diameter (Dp), and Particle Size Distribution of Carrier>

The weight average particle diameter (Dw), the number average particle diameter (Dp), and the particles size distribution of the carrier were measured using a micro track particle size analyzer (Model HRA9320-X100 produced by Honewell Corp.).

<Magnetic Moment (Magnetization) in 1 kOe Carrier>

The magnetization of the carrier can be measured as follows using B—H tracer (BHU-60 manufactured by Riken Denshi Co., Ltd.). First, 1 g of core material particles was packed in a cylindrical cell, and the cylindrical cell was set to a magnetization measurement device. The magnetic filed was gradually increased up to 3 kOe, and then the magnetic field was gradually reduced to zero, and the opposite magnetic field was gradually increased up to 3 kOe. Then, the opposite magnetic filed was gradually reduced to zero, and a magnetic field was applied in the same direction as the initially applied direction. In this way, a B—H curve was prepared to calculate the magnetization of lkOe based on the B—H curve.

### Example 1

—Preparation of Carrier 1—

A mixture of Fe₂O₃, CuO, and ZnO was pulverized using a wet-process ball mill such that the particle diameter of the pulverized product was 1 μm or less. To the thus obtained pulverized product, polyvinyl alcohol was added, and the pulverized product was granulated using a spray drier. The granulated product was sintered in an electric furnace, and the sintered product was then fuse-crushed, classified, and the grain size thereof was adjusted to thereby obtain a core material 1. The components of the core material 1 were analyzed, and it was found that the core material 1 contained Fe₂O₃ at 46 mole %, CuO at 27 mole %, and ZnO at 27 mole %.

Next, in a silicone resin (SR2411 manufactured by DOW CORNING TORAY SILICONE CO., LTD.), a solution of a conductive carbon having a specific surface area of 1,270 m²/g that had been prepared such that the content of the conductive carbon was 5% by mass relative to the solid content of the silicone resin was dispersed for 30 minutes using a homogenizer. The obtained dispersion fluid was diluted such that the solid content thereof was 10% by mass. Then, to the diluent, an aminosilane coupling agent represented by the chemical formula H₂N (CH₂)₃ Si(OCH₃)₃ was added in a content of 3% by mass relative to the solid content of the silicone resin and mixed with the diluent to thereby obtain a coating solution for a coating layer of the core material 1.

Next, the core material 1 was coated with the coating solution for the coating layer using a fluidized bed coating apparatus under an atmosphere of 100° C. at a coating rate of 50 g/minute. The coated core material was heated at 250° C. for 2 hours to thereby prepare a carrier 1 having properties shown in Tables 1 and 2 and a coating layer having an average thickness of 0.6 μm.

### Example 2

—Preparation of Carrier 2—

A carrier 2 having properties shown in Tables 1 and 2 and a coating layer having an average thickness of 0.6 μm was prepared in the same manner as in Example 1 except that a core material 2 which was prepared by changing the classifying condition and the grain size controlling conditions was used.

### Example 3

—Preparation of Carrier 3—

A carrier 3 having properties shown in Tables 1 and 2 and a coating layer having an average thickness of 0.6 μm was prepared in the same manner as in Example 2 except that a core material 3 was used, of which the surface of the core material 2 was subjected to a plasma treatment and then the core material was classified and the grain size was adjusted.

### Example 4

—Preparation of Carrier 4—

A mixture of Fe₂O₃, MnO, MgO and SrCO₃ was pulverized using a wet-process ball mill such that the particle diameter of the pulverized product was 1 μm or less. To the thus obtained pulverized product, polyvinyl alcohol was added, and the pulverized product was granulated using a spray drier. The granulated product was sintered in an electric furnace, and the sintered product was then fuse-crushed and classified, and the grain size thereof was adjusted to thereby obtain a core material 4. The components of the core material 4 were analyzed, and it was found that the core material contained Fe₂O₃ at 47 mole %, MnO at 38 mole %, MgO at 14 mole %, and SrCO₃ at 1 mole %.

A silicone resin coating layer was formed on the thus obtained core material 4 in the same manner as in Example 1. The thus obtained powder was heated and dried at 250° C. for 2 hours to thereby prepare a carrier 4 having properties shown in Tables 1 and 2 and a coating layer having an average thickness of 0.6 μm.

### Example 5

—Preparation of Carrier 5—

Fe₂O₃ was pulverized using a wet-process ball mill such that the particle diameter of the pulverized product was 1 μm or less. To the thus obtained pulverized product, polyvinyl alcohol was added, nd the pulverized product was granulated using a spray drier. The granulated product was sintered in an electric furnace, and the sintered product was then fuse-crushed and classified, and the grain size thereof was adjusted to thereby obtain a core material 5.

A silicone resin coating layer was formed on the thus obtained core material 5 in the same manner as in Example 1. The thus obtained powder was heated and dried at 250° C. for 2 hours to thereby prepare a carrier 5 having properties shown in Tables 1 and 2 and a coating layer having an average thickness of 0.6 μm.

### Example 6

—Preparation of Carrier 6—

A mixture of Fe₂O₃ and MnO was pulverized using a wet-process ball mill such that the particle diameter of the pulverized product was 1 μm or less. To the thus obtained pulverized product, polyvinyl alcohol was added, and the pulverized product was granulated using a spray drier. The granulated product was sintered in an electric furnace, and the sintered product was then fuse-crushed and classified, and the grain size thereof was adjusted to thereby obtain a core material 6. The components of the core material 6 were analyzed, and it was found that the core material 6 contained Fe₂O₃ at 78 mole % and MnO at 22 mole %.

A silicone resin coating layer was formed on the thus obtained core material 6 in the same manner as in Example 1. The thus obtained powder was heated and dried at 250° C. for 2 hours to thereby prepare a carrier 6 having properties shown in Tables 1 and 2 and a coating layer having an average thickness of 0.6 μm.

### Example 7

—Preparation of Carrier 7—

A carrier 7 having properties shown in Tables 1 and 2 and a coating layer having an average thickness of 0.6 μm was prepared in the same manner as in Example 6 except that a core material 7 which was prepared by changing the classifying condition and the grain size controlling conditions used in the core material 6 was used.

### Example 8

—Preparation of Carrier 8—

A carrier 8 having properties shown in Tables 1 and 2 and a coating layer having an average thickness of 0.6 μm was prepared in the same manner as in Example 7 except that a core material 8 was used, of which the surface of the core material 7 was subjected to a plasma treatment and then the core material was classified and the grain size was adjusted.

### Comparative Example 1

—Preparation of Carrier 9—

A carrier 9 having properties shown in Tables 1 and 2 and a coating layer having an average thickness of 0.6 μm was prepared in the same manner as in Example 6 except that a mixture of Fe₂O₃ and MnO was pulverized using a wet-process ball mill such that the average particle diameter of the pulverized product was 5 μm.

### Comparative Example 2

—Preparation of Carrier 10—

An iron powder was pulverized using a wet-process ball mill such that the particle diameter of the pulverized product was 1 μm or less. To the thus obtained pulverized product, polyvinyl alcohol was added, and the moisture contained in the pulverized product was dried using a spray drier to thereby obtain a granulated material. The granulated material was sintered in an electric furnace, and then the sintered material was classified, and the grain size thereof was adjusted to thereby obtain a core material 10.

A silicone resin coating layer was formed on the thus obtained core material 10 in the same manner as in Example 1. The thus obtained powder was heated and dried at 250° C. for 2 hours to thereby prepare a carrier 10 having properties shown in Tables 1 and 2 and a coating layer having an average thickness of 0.6 μm.

### Example 9

—Preparation of Carrier 11—

A carrier 11 having properties shown in Tables 1 and 2 and a coating layer having an average thickness of 0.6 μm was prepared in the same manner as in Example 2 except that a coating layer was formed using a coating solution that had been prepared by adding a hydrophobized silica (R972 manufactured by Nippon AEROSIL CO., LTD.) to a coating solution for the coating layer with a content of 20 parts relative to the solid content of the coating solution for the coating layer and dispersing the hydrophobized silica in the coating solution for 20 minutes using a homogenizer.

### Example 10

—Preparation of Carrier 12—

A carrier 12 having properties shown in Tables 1 and 2 and a coating layer having an average thickness of 0.6 μm was prepared in the same manner as in Example 2 except that a coating layer was formed using a coating solution that had been prepared by adding alumina fine particles having a particle diameter of 0.3μm to a coating solution for the coating layer with a content of 10 parts relative to the solid content of the coating solution for the coating layer and dispersing the alumina fine particles in the coating solution using a homogenizer in the same manner as described above.

### Example 11

—Preparation of Carrier 13—

A carrier 13 having properties shown in Tables 1 and 2 and a coating layer having an average thickness of 0.6 μm was prepared in the same manner as in Example 2 except that a coating layer was formed using a coating solution that had been prepared by adding rutile titanium oxide particles having a particle diameter of 15 nm to a coating solution for the coating layer with a content of 20 parts relative to the solid content of the coating solution for the coating layer and dispersing the rutile titanium oxide particles in the coating solution using a homogenizer in the same manner as described above.

TABLE 1

| | | | Composition | | Bulk | |
|---|---|---|---|---|---|---|
| | | | of | Particle density | density | |
| | Carrier | Core material | core material | (g/cm³) | (g/cm³) | ρp/ρb |
| Ex. 1 | Carrier 1 | Core material 1 | CuZn ferrite | 4.9 | 2.3 | 2.1 |
| Ex. 2 | Carrier 2 | Core material 2 | CuZn ferrite | 4.9 | 2.2 | 2.2 |
| Ex. 3 | Carrier 3 | Core material 3 | CuZn ferrite | 4.9 | 2.6 | 1.9 |
| Ex. 4 | Carrier 4 | Core material 4 | MnMgSr ferrite | 4.6 | 2.2 | 2.1 |
| Ex. 5 | Carrier 5 | Core material 5 | Magnetite | 4.8 | 2.2 | 2.2 |
| Ex. 6 | Carrier 6 | Core material 6 | Mn ferrite | 4.5 | 2.6 | 1.7 |
| Ex. 7 | Carrier 7 | Core material 7 | Mn ferrite | 4.6 | 2.2 | 2.1 |
| Ex. 8 | Carrier 8 | Core material 8 | Mn ferrite | 4.5 | 2.5 | 1.8 |
| Compara. | Carrier 9 | Core material 9 | Mn ferrite | 3.8 | 1.9 | 2.1 |
| Ex. 1 | | | | | | |
| Compara. | Carrier | Core material 10 | Iron powder | 6.8 | 3.9 | 1.7 |
| Ex. 2 | 10 | | | | | |
| Ex. 9 | Carrier | Core material 2 | CuZn ferrite | 4.9 | 2.2 | 2.2 |
| | 11 | | | | | |
| Ex. 10 | Carrier | Core material 2 | CuZn ferrite | 4.9 | 2.2 | 2.2 |
| | 12 | | | | | |
| Ex. 11 | Carrier | Core material 2 | CuZn ferrite | 4.9 | 2.2 | 2.2 |
| | 13 | | | | | |

TABLE 2

| | | | | | Content | Content | |
|---|---|---|---|---|---|---|---|
| | | | | | rate | rate | |
| | | | | | of | of | |
| | | | | | particles | particles | |
| | | | | | having | having | |
| | | | Weight | | particle | particle | |
| | | | average | | diameter | diameter | |
| | | | particle | | of 0.02 μm | of 0.02 μm | |
| | | | diameter | | to 20 μm | to 36 μm | Magnetization |
| | Carrier | Core material | Dw (μm) | Dw/Dp | (%) | (%) | (emu/g) |
| Ex. 1 | Carrier 1 | Core material 1 | 37.5 | 1.16 | 0.1 | 50.7 | 56 |
| Ex. 2 | Carrier 2 | Core material 2 | 27.6 | 1.13 | 6.2 | 90.6 | 56 |
| Ex. 3 | Carrier 3 | Core material 3 | 29.3 | 1.14 | 5.5 | 84.3 | 56 |
| Ex. 4 | Carrier 4 | Core material 4 | 27.7 | 1.13 | 6.5 | 91.0 | 59 |
| Ex. 5 | Carrier 5 | Core material 5 | 27.6 | 1.13 | 6.4 | 90.8 | 76 |
| Ex. 6 | Carrier 6 | Core material 6 | 38.3 | 1.16 | 0.1 | 46.4 | 56 |
| Ex. 7 | Carrier 7 | Core material 7 | 27.2 | 1.13 | 6.8 | 90.1 | 65 |
| Ex. 8 | Carrier 8 | Core material 8 | 26.5 | 1.12 | 5.0 | 91.8 | 62 |
| Compara. | Carrier 9 | Core material 9 | 27.2 | 1.13 | 6.8 | 90.1 | 65 |
| Ex. 1 | | | | | | | |
| Compara. | Carrier | Core material | 28.5 | 1.12 | 5.3 | 91.2 | 105 |
| Ex. 2 | 10 | 10 | | | | | |
| Ex. 9 | Carrier | Core material 2 | 27.6 | 1.13 | 6.2 | 90.6 | 56 |
| | 11 | | | | | | |
| Ex. 10 | Carrier | Core material 2 | 27.6 | 1.13 | 6.2 | 90.6 | 56 |
| | 12 | | | | | | |
| Ex. 11 | Carrier | Core material 2 | 27.6 | 1.13 | 6.2 | 90.6 | 56 |
| | 13 | | | | | | |

### Production Example 1

—Preparation of Toner—

Polyester resin . . . 100 parts

Quinacridone magenta pigment . . . 3.5 parts

Fluorine-containing quaternary ammonium salt . . . 4 parts

The components stated above were sufficiently mixed, and the mixture was fused and kneaded using a biaxial extruder. The kneaded product was cool-rolled, and the cool-rolled product was coarsely crushed using a cutter mill. Next, the coarsely crushed product was finely pulverized in a jet stream pulverizing mill, and the pulverized powder was classified using an air classifier to thereby obtain a toner base having a weight average particle diameter of 6.8 pm and an absolute specific gravity of 1.2.

Next, to 100 parts of the obtained toner base, 0.8 parts of hydrophobized silica fine particles (R972 manufactured by Nippon AEROSIL CO., LTD.) were added, and the components were mixed and then sieved to thereby prepare a toner.

### Examples 12 to 22 and Comparative Examples 3 to 4

—Preparation of Developer—

To respective 100 parts of the carriers 1 to 13, 8 parts of the toner prepared in Production Example 1 were added, and the components were agitated in a ball mill for 20 minutes to thereby prepare respective developers of Examples 12 to 22 and Comparative Examples 3 to 4.

—Formation of Image—

Using the respective developers, an image was formed in a digital color copier/printer complex unit (imagio Color 4000 manufactured by Ricoh Company Ltd.), and the imaging performance was evaluated in the following procedures. Table 3 shows the evaluation results.

<Image Density>

The image density of the center portion of a 30 mm×30 mm solid part of the printed image was measured at 5 sites under the above-mentioned developing conditions using X-Rite 938 spectrophotometric colorimetry densitometer, and the respective developers were evaluated as to image density in accordance with the following criteria.

[Evaluation Criteria]

A: Very excellent

B: Excellent

C: Poor (unallowable level)

<Granularity>

For the respective developers, the granularity defined by the following Equation 1 (brightness range: 50 to 80) was measured, and based on the calculated value, the respective developers were evaluated as to the granularity in accordance with the following criteria.
Granularity=e×p(a L+b)ƒ(WS(f))^{1/2}·VTF(f)df

In the Equation 1, L represents the average brightness, “f” represents a space frequency (cycle/mm), WS (f) represents a power spectrum of brightness variations, VTF (f) represents a visual property of space frequency, and “a” and “b” respectively represent a coefficient.

[Evaluation Criteria]

| | |
|---|---|
| A (vary excellent) | zero or more to less than 0.1 |
| B (excellent) | 0.1 or more to less than 0.2 |
| C (allowable to use) | 0.2 or more to less than 0.3 |
| D (unallowable to use) | 0.3 or more |

<Evaluation of Background Smear>

The degree of contamination (smear) of background portions of the image was visually checked, and the respective developers were evaluated and judged as A: very excellent, B: excellent, and C: poor (unallowable level).

<Carrier Adhesion>

Only a part of the carrier was transferred onto a sheet of paper even when carrier adhesion actually occurred, and thus a part of the carrier on the photoconductor was transferred onto a sheet of paper with a pressure-sensitive adhesive tape, and the respective developers were evaluated as to the carrier adhesion. Specifically, the charge potential (Vd) was set to −750V, and the developing bias (Vd) was set to DC-400V, a background portion (unexposed area) was developed, and the number of carrier particles adhering to an area of 30 cm² on the photoconductor was directly counted to thereby evaluate the respective developers as to the carrier adhesion in accordance with the following criteria.

[Evaluation Criteria]

A: Very excellent

B: Excellent

C: Poor (unallowable level)

<Evaluation of Background Smear and Carrier Adhesion After Running Output of 20,000 sheets>

The level of background smear and the level of carrier adhesion on the respective developers after running output of 20,000 sheets of a 6% letter image-area ratio chart were evaluated in the same manner as described above.

TABLE 3

| | | | | | | | Carrier |
|---|---|---|---|---|---|---|---|
| | | | | | | Background | adhesion |
| | | | | | | smear after | after |
| | | | | | | running | running |
| | | | | | | output of | output of |
| | | Image | | Background | Carrier | 20,000 | 20,000 |
| | Carrier | density | Granularity | smear | adhesion | sheets | sheets |
| Ex. 12 | Carrier 1 | B | C | A | A | B | A |
| Ex. 13 | Carrier 2 | A | B | A | A | B | B |
| Ex. 14 | Carrier 3 | A | A | A | A | A | A |
| Ex. 15 | Carrier 4 | A | B | A | A | B | B |
| Ex. 16 | Carrier 5 | A | B | A | A | B | B |
| Ex. 17 | Carrier 6 | B | B | A | A | A | A |
| Ex. 18 | Carrier 7 | A | B | A | A | B | B |
| Ex. 19 | Carrier 8 | A | A | A | A | A | A |
| Compara. | Carrier 9 | A | B | A | C | C | C |
| Ex. 3 | | | | | | | |
| Compara. | Carrier | A | C | A | A | C | C |
| Ex. 4 | 10 | | | | | | |
| Ex. 20 | Carrier | A | B | A | A | A | A |
| | 11 | | | | | | |
| Ex. 21 | Carrier | A | B | A | A | A | A |
| | 12 | | | | | | |
| Ex. 22 | Carrier | A | B | A | A | A | A |
| | 13 | | | | | | |

The carrier of the present invention causes less occurrences of carrier adhesion, has high image density and excellent granularity, enables exhibiting stable charge imparting ability over a long period of time, and is preferably used in developers which are used for electrophotographic image forming.

The developer of the present invention using the carrier of the present invention can be preferably used in image forming based on various electrophotographic methods and can be particularly preferably used for developer containers, process cartridges, image forming apparatuses, and image forming methods.

What is claimed is:

1. A carrier comprising:
core material particles having magnetism, and
a coating layer on the surfaces of the core material particles,
wherein the particle density of the core material particles is 4.0 g/cm³ to 6.0 g/cm³, and the bulk density of the core material particles is 2.0 g/cm³ to 3.0 g/cm³.

2. The carrier according to claim 1, wherein the ratio (ρp/ρb) of the particle density (ρp) of the core material particles relative to the bulk density (ρb) of the core material particles is 1.6 to 1.9.

3. The carrier according to claim 1, wherein the particle density of the core material particles is 4.5 g/cm³ to 5.5 g/cm³.

4. The carrier according to claim 1, wherein the coating layer comprises an aminosilane coupling agent.

5. The carrier according to claim 1, wherein the coating layer comprises hard particles.

6. The carrier according to claim 5, wherein the hard particles comprise at least one selected from Sioxide particles, Ti oxide particles, and Al oxide particles.

7. The carrier according to claim 1, wherein the weight average particle diameter of the carrier is 22 μm to 32 μm; the ratio (Dw/Dp) of the weight average particle diameter (Dw) of the carrier relative to the number average particle diameter (Dp) of the carrier is 1.0 to 1.2; the content of carrier particles having a particle diameter of 0.02 μm to 20 μm is 0% by mass to 7% by mass; the content of carrier particles having a particle diameter of 0.02 μm to 36 μm is 90% by mass to 100% by mass; and the magnetic moment at the time when a magnetic field of 1 kOe is applied to the carrier is 50 emu/g to 150 emu/g.

8. A developer comprising:
a carrier which comprises core material particles having magnetism, and a coating layer on the surfaces of the core material particles, and
a toner,
wherein the particle density of the core material particles is 4.0 g/cm³ to 6.0 g/cm³, and the bulk density of the core material particles is 2.0 g/cm³ to 3.0 g/cm³.

9. An image forming method comprising:
forming a latent electrostatic image on a photoconductor,
developing the latent electrostatic image using a developer to form a visible image,
transferring the visible image onto a recording medium, and
fixing the transferred image on the recording medium,
wherein the developer comprises a carrier which comprises core material particles having magnetism and a coating layer on the surfaces of the core material particles, and a toner; the particle density of the core material particles is 4.0 g/cm³ to 6.0 g/cm³, and the bulk density of the core material particles is 2.0 g/cm³ to 3.0 g/cm³.

10. An image forming apparatus comprising:
a photoconductor,
a latent electrostatic image forming unit configured to form a latent electrostatic image on the photoconductor,
a developing unit configured to develop the latent electrostatic image using a developer to form a visible image,
a transferring unit configured to transfer the visible image onto a recording medium, and
a fixing unit configured to fix the transferred image on the recording medium,
is wherein the developer comprises a carrier which comprises core material particles having magnetism and a coating layer on the surfaces of the core material particles, and a toner; the particle density of the core material particles is 4.0 g/cm³ to 6.0 g/cm³, and the bulk density of the core material particles is 2.0 g/cm³ to 3.0 g/cm³.

11. A process cartridge capable of being detachably attached to a body of an image forming apparatus, comprising:
a photoconductor, and
a developing unit configured to develop a latent electrostatic image formed on the photoconductor using a developer to form a visible image,
wherein the developer comprises a carrier which comprises core material particles having magnetism and a coating layer on the surfaces thereof, and a toner; the particle density of the core material particles is 4.0 g/cm³ to 6.0 g/cm³, and the bulk density of the core material particles is 2.0 g/cm³ to 3.0 g/cm³.
